(19) United States
(12) Patent Application Publication
(10) Pub. No.: US 2002/0065679 A1
(43) Pub. Date: May 30, 2002

(54) Contextual index based information soliciting retrieval and self-updating management systems and methods

(76) Inventor: Philippe Laberge, Green Field Park (CA)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/991,947

(22) Filed: Nov. 26, 2001

Related U.S. Application Data
(60) Provisional application No. 60/252,890, filed on Nov. 27, 2000.

(51) Int. Cl. G06F 17/60

(52) U.S. Cl. 705/1

(57) ABSTRACT

A system is described through which a building firm can locate one or more supply firms who provide products that the building firm requires for a building project, and through which building firms can maintain an electronic archive of building product specifications and other product information, comprising: a self-updating electronic database of building products and suppliers, a computer-network facilitated communication system through which building firms communicate with suppliers, and a computer to which suppliers can upload product specifications and building firms can create links to those product specifications.

### CROSS-REFERENCE TO RELATED APPLICATION

This application claims priority to U.S. Provisional Patent Application No. 60/252,890, filed Nov. 27, 2000.

### BACKGROUND

1. Field of the Invention

This invention relates to a service for locating suppliers of specialized building materials by using a self-updating electronic database of suppliers and products and electronic query and notification systems.

2. Related Art

Architectural, construction, interior design, and related firms (building firms) generally use a great number of different suppliers for any given construction project. Such projects require equipment, building supplies such as concrete, masonry, metals, wood and plastic, insulation, sealants, doors, windows, plumbing supplies, electrical supplies, and other specialized products. The use of many different suppliers for a single project places a burden on building firms to locate the suppliers for their various building needs. Traditionally, this burden has been met by the building firms manually searching through printed publications that list building product suppliers under broad product categories. However, this method suffers from the drawback that a building firm must screen a number of suppliers to determine which supplier provides the specific product that the building firm requires and whether the product meets the specifications of the particular project. Therefore, there is a need for a system that can automatically contact a number of suppliers with a query as to whether each supplier provides a particular product, and can automatically screen those suppliers, thus reporting only those suppliers that supply that product.

Once a building firm finds a supplier for a needed product, that supplier typically provides a printed specification describing the product to the building firm. The building firm eventually locates several suppliers for all of the products that the building firm requires for a particular project, and thus gathers a large number of printed specifications describing a number of the products needed for a particular building project. Thus, the building firm acquires and maintains a library of product catalogs from a number of suppliers for use in finding suppliers of products for subsequent building projects. However, if similar products are required for a subsequent building project, the building firm must contact the suppliers to inquire as to whether those printed specifications still accurately describe the products that the suppliers provide, or whether the products have changed substantially. Therefore, there is a need for a system that can store and organize product specifications and that allows those specifications to be updated if suppliers of the products have changed the products.

The Construction Specification Institute (CSI) MasterFormat Index™ is a three-tiered index of building product specifications. The first level of the index broadly classifies products as related to sitework, concrete, masonry, metals, wood and plastic, thermal and moisture protection, doors and windows, finishes, specialties, equipment, furnishings, special construction, conveying systems, mechanical, or electrical. Each of the broad classifications has a number of narrower classifications in the second level of the index. For example, the first level masonry category includes the following second level categories: basic masonry materials and methods, masonry units, stone, refractories, corrosion-resistant masonry, simulated masonry, masonry assemblies, and masonry restoration and cleaning. Similarly, each of the second level categories is divided into additional narrower classifications in the third level of the index. For example, the second level stone category includes the following third level categories: stone materials, collected stone, and quarried stone. However, even the third level categories of the index are very broad, and a building firm seeking a particular type of stone for a masonry project would have trouble selecting a supplier for the particular stone product they seek given the breadth of even the narrowest level of categories.

Therefore, there is a need to supplement the third level of categories with additional levels that describe the products themselves in sufficient detail that a building firm seeking a particular building product would be able to easily identify desired products.

### SUMMARY OF THE INVENTION

This invention provides solutions to the problems that building firms face when they seek suppliers of the building products required for a new building project. The invention uses a computer network to facilitate the location of supply firms by building firms, and to facilitate communication between the supply and building firms. The invention allows building firms to either specify the products they need, or to browse through a detailed index of products, select the products they need, and automatically contact suppliers of those products. The invention provides for a self-updating database of products and suppliers. Finally, the invention allows building firms to compile and maintain an online library of product specifications that the suppliers of those products can update when they change the products.

As should be readily apparent to one of ordinary skill in the art, the application of this invention is not limited to the building and construction sectors. This invention can easily be adapted for use in a broad variety of other sectors, including the automotive, medical, or aviation sectors. The invention is particularly suited for sectors in which specialized products are required for specialized projects. For purposes of illustration only, and without any loss of generality, the invention will be described as it would apply to the building and construction sector.

In one aspect, the invention includes a categorization of the products from many suppliers based on descriptions of the products, and a classification of the products within the categories of the Construction Specification Institute (CSI) MasterFormat Index™. This enhanced CSI index, with eight times as many categories as the standard CSI index, will be referred to as the information gathering system (IGS) index. A database is assembled from this categorization where each product provided by a particular supplier is grouped within the appropriate IGS category, and each product is described in sufficient detail to distinguish it from the other products in the same category. By browsing through such a database, a building firm can quickly and easily locate the exact product it seeks.

In another aspect, the invention includes a system for screening a number of potential suppliers of a particular product to find a subset of suppliers that provide the particular product that a building firm seeks. The building firm selects a product from the database described above, or enters a textual description of the product that the firm seeks, or both. The building firm may provide other relevant information as well, such as the geographical location of the project for which the product is needed or other criteria that the building firm considers important. The building firm may also provide sketches or drawings that indicate the particular problem that a supplier's product might solve. The system then identifies suppliers of that product from the database based on the building firm's selection or description and notifies those suppliers of the building firm's need for that product. The system may filter the suppliers who receive such notification by excluding suppliers who do not fit the building firm's criteria. For example, it may exclude suppliers who are too distant from the location of the project for which the product is needed. The suppliers then notify the building firm that they provide such a product, and upload information about the product to a computer that is network-accessible to the building firm, thus enabling the building firm to download specifications relating to the suppliers' products.

In another aspect, the invention includes a method for maintaining a database of products and suppliers. In this aspect, a building firm either selects a product from the database, or enters a textual description of the product that the firm seeks. The system then identifies potential suppliers of that product from the database based on the building firm's selection or description of the product, and sends notification to those potential suppliers that the building firm seeks such a product. Any identified potential suppliers that do not provide a product matching the description notify the system that they do not actually provide such a product. The system then updates the database accordingly by removing the suppliers who so notified the system from the suppliers listed in the database as providing that product.

### DESCRIPTION OF THE FIGURES

FIG. 1 is a schematic diagram of one embodiment of the invention.

FIG. 2 is an example of a building firm's archive entry set up.

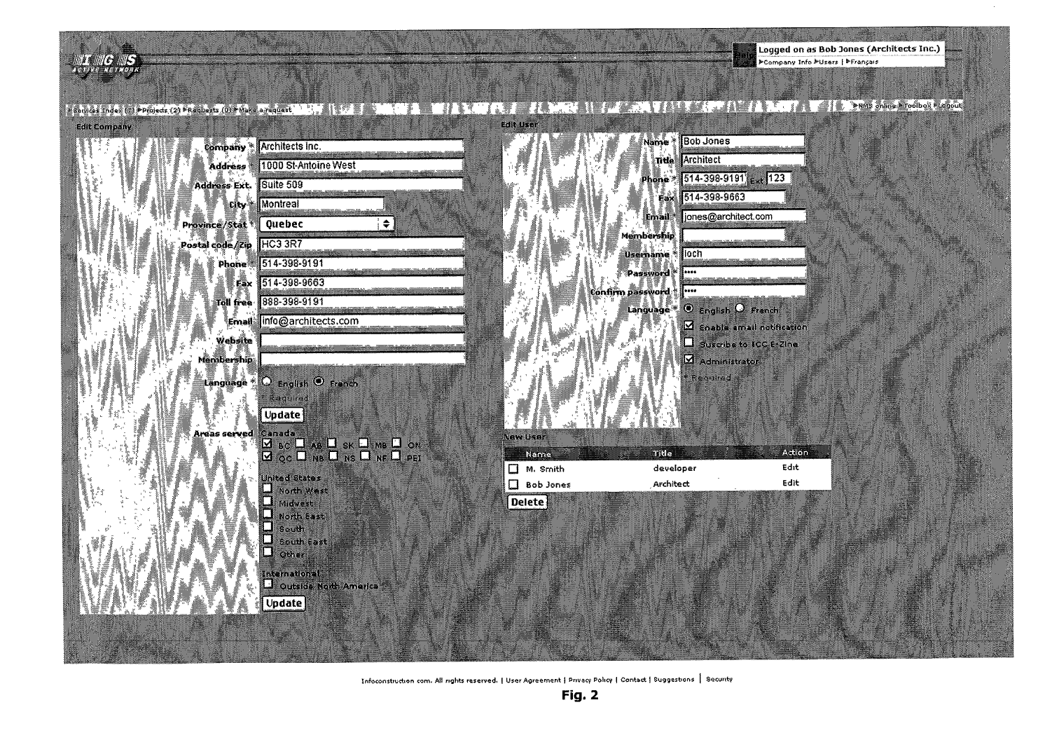

FIG. 3 is an example of a building firm's product request.

FIG. 4 is an example of a request for information sent to a supplier following a building firm's product request.

FIG. 5 is an example of a response form that a supplier uses to respond to a request by a building firm for information.

FIG. 6 shows an internet browser implementation used for viewing a building firm's archive.

FIG. 7A is an example of a response from a supplier received by a building firm.

FIG. 7B is an example of a request screen for a building firm to direct further requests for information to a supplier.

FIG. 8 is an example of a supplier's indexed product line.

FIG. 9 is an example of a supplier's Control Center.

### DETAILED DESCRIPTION OF THE PREFERRED EMBODIMENTS

This invention is a peer-to-peer application service that addresses the primary tasks handled by design, building, and decorating professionals and general contractors, project managers, and facility managers in the construction industry (“building firms”) including the identification, acquisition, and management of construction product information. The invention includes features such as a searchable and browsable index of products described in sufficient detail that a building firm seeking a particular product would recognize that product by its description. This searchable and browsable index of products is self-updating and self-correcting by virtue of a feature wherein when suppliers indicate that they do not supply a given product, the database is automatically updated to remove those suppliers from the list of suppliers within the database that correspond to the suppliers of that product.

The invention further includes a system by which building product suppliers can index their product line according to the IGS index and also list products that they do not supply, but to which their products may serve as alternatives. They can also upload information relating to their products, such as product photographs, brochures, specifications, computer-aided-design (CAD) files, and material safety data sheets (MSDS). Also included is a system by which building firms can create libraries or archives of product information by creating links to product photographs, brochures, specifications, CAD files, and MSDSs. The links allow the building firms to download electronic versions of photographs, brochures, specifications, CAD files, and material safety data sheets relating to products of interest to the building firms. The libraries or archives may be self-updating with links that point to files on a computer server to which suppliers have upload access. In such an embodiment, when the suppliers change a product, and consequently change a photograph, brochure, specification, CAD file, or MSDSs corresponding to that product, the suppliers can upload the new versions of the photograph, brochure, specification, or CAD file corresponding to the changed product. Thus, when building firms access links corresponding to particular products, they obtain the most up-to-date information about those products.

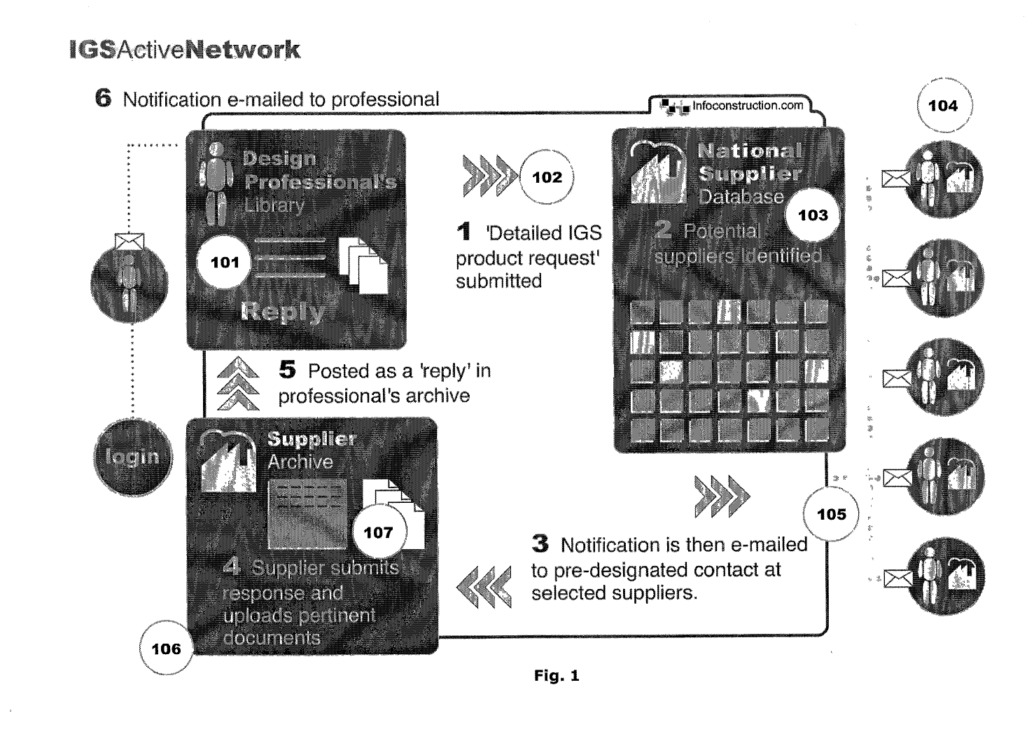

One embodiment of the invention is shown in FIG. 1. In this embodiment, a building firm 101 accesses a computer server that provides an electronic form that the firm fills out, detailing a request 102 for a product that the firm requires for a building project. The detailed request 102 may be generated, for example, using an electronic hypertext form to specify exactly what product the firm seeks. The detailed request 102 is processed by a computer 103 provided by the service, which then searches a supplier database on the computer 103 to identify potential suppliers 104 that provide the product. An electronic notification 105 is sent by the service to the identified potential suppliers 104, for example, by e-mail. Potential suppliers may respond to the electronic notification 105 using an electronic response form 106 indicating whether or not they provide that product. If a supplier indicates that it does not provide that product, the service then updates the supplier database 103 to remove that supplier from the list of suppliers designated in the supplier database as providing that product. “Confirmed suppliers” are those potential suppliers 104 that respond to the electronic notification indicating that they do provide the product. The confirmed suppliers may send a second electronic notification, for example by e-mail response to the first notification, to the building firm 101, informing the firm that they do provide the product. Alternatively, the confirmed suppliers send a response to the service by replying to a message they receive when they log onto the system, and this response then updates the building firm's archive to indicate the identities of the confirmed suppliers. The confirmed suppliers may also upload electronic documents and data 106, including photographs, brochures, specifications, CAD files and MSDSs to a virtual library 107 that is maintained by the service. The building firm can then access these electronic documents through hyperlinks and by downloading them from the virtual library 107.

The firm can browse through the products listed in the supplier database 103 using, for example, a web browser. In one embodiment, the supplier database is organized according to the CST MasterFormat Index™; in a preferred embodiment, the supplier database is organized according to the more detailed IGS index. In this embodiment, the firm is presented with a list of broad categories of products including sitework, concrete, masonry, metals, wood and plastic, thermal and moisture protection, doors and windows, finishes, specialties, equipment, furnishings, special construction, conveying systems, mechanical, and electrical. The firm selects the broad category that contains the product it seeks.

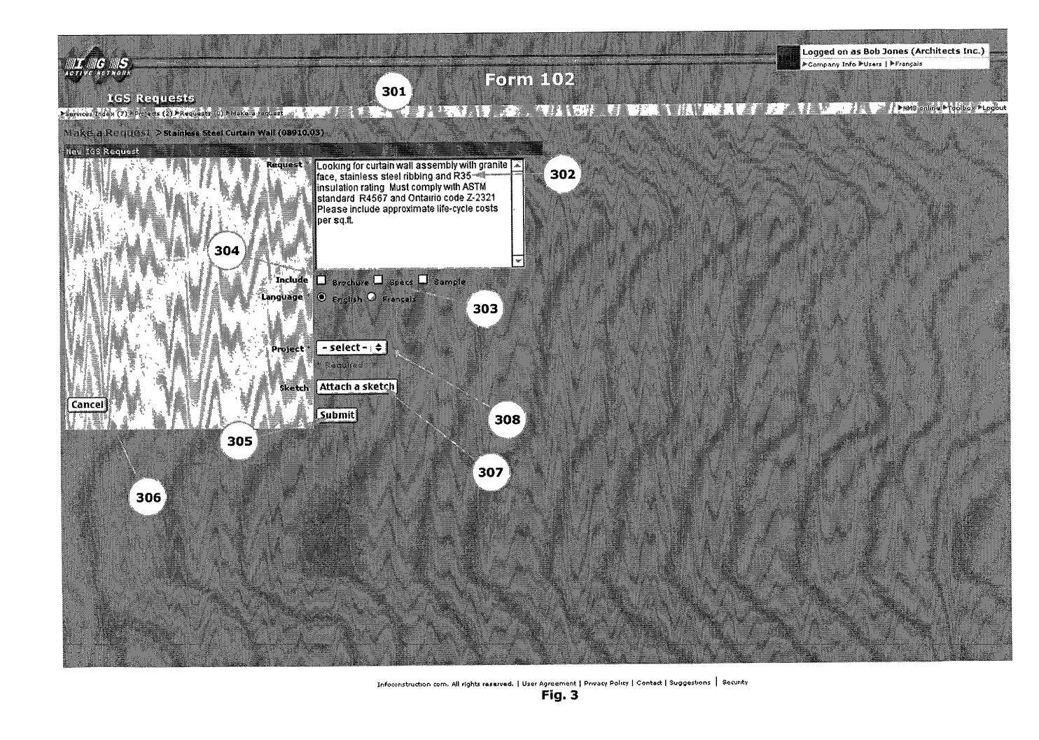

For example, in the detailed request form 102 shown in FIG. 3, the form is a hypertext form created for use with a standard web browser. The product the firm is seeking is listed in field 301, in this case a glazed stainless steel curtain wall. The firm could find that product either by a keyword or phrase search of the database, or by browsing. If the firm chooses to browse, it would select the broad category that covers the product it seeks. In this example, the firm would select the “doors and windows” category. The firm will then be presented with a number of intermediate categories: metal doors and frames, wood and plastic doors, specialty doors, entrances and storefronts, windows, skylights, hardware, glazing, and glazed curtain walls. The firm would select the intermediate category “glazed curtain walls,” and be presented with the narrowest categories: metal framed curtain wall, and translucent wall and roof assemblies. The firm should then select the “metal framed curtain wall” category, and finally it will be presented with a list of products from this category to choose from: glazed aluminum curtain wall, glazed bronze curtain wall, glazed stainless steel curtain wall, and glazed steel curtain wall. Each of the products listed in this deepest level of the index described above is associated with a unique numerical identifier called the IGS index.

The firm should select “glazed steel curtain wall,” and a detailed request form will appear as in FIG. 3. In one embodiment, the detailed request form has a text box 302 in which the firm may enter any additional information about the product it seeks. Button 308 allows the firm to specify the project for which the information is needed. If the firm requires product specifications or brochures, it may check the check boxes 303 and 304 on the detailed request form. The firm then clicks the “submit” button 305 or the “cancel” button 306 if the wrong product was erroneously selected. The firm can also submit a sketch or technical drawing by clicking on the “Attach a sketch” button 307 and selecting the appropriate file on his computer's database.

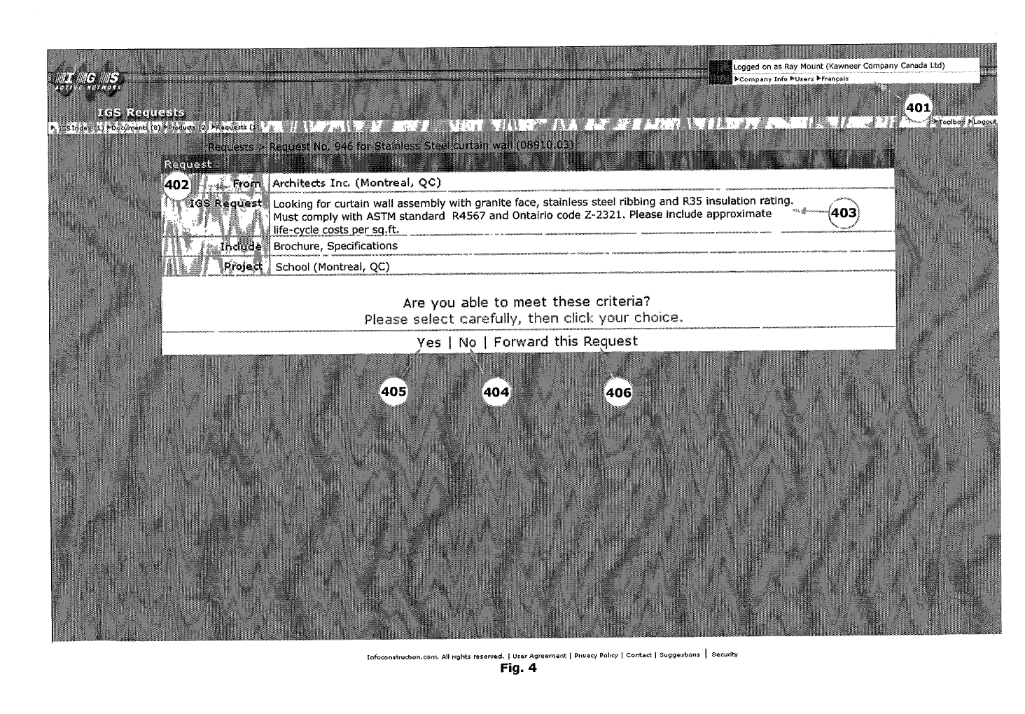

The “submit” button causes electronic notifications 105 of requests for information to be sent to potential suppliers of the particular product selected (in this example, a glazed steel curtain wall), for example, by text e-mail, hypertext email, instant messaging, or other delivery method known in the art. The service identifies potential suppliers by reference to the supplier database as those designated as providing the particular product selected, and sends the electronic notifications to the identified potential suppliers. An example of an electronic notification is shown in FIG. 4. The electronic notification indicates who the request for information is addressed to 401, who requested the information 402, and displays the additional information text 403 entered by the building firm in its detailed request form. A potential supplier who receives such a notification has three options: respond affirmatively, respond negatively, or forward the message. For example, if the person receiving the notification is not qualified to answer affirmatively or negatively, he can forward the message to another person within the supplying firm who is so qualified by clicking on the “Forward this request” button 406. If the supplier responds negatively by clicking button 404, a notification is sent to the service computer that maintains the supplier database, and the supplier is removed from the list of suppliers designated as providing that product. Thus, if future requests for the product are made, the supplier who indicated that it does not provide that product will not receive an electronic notification of a request for information.

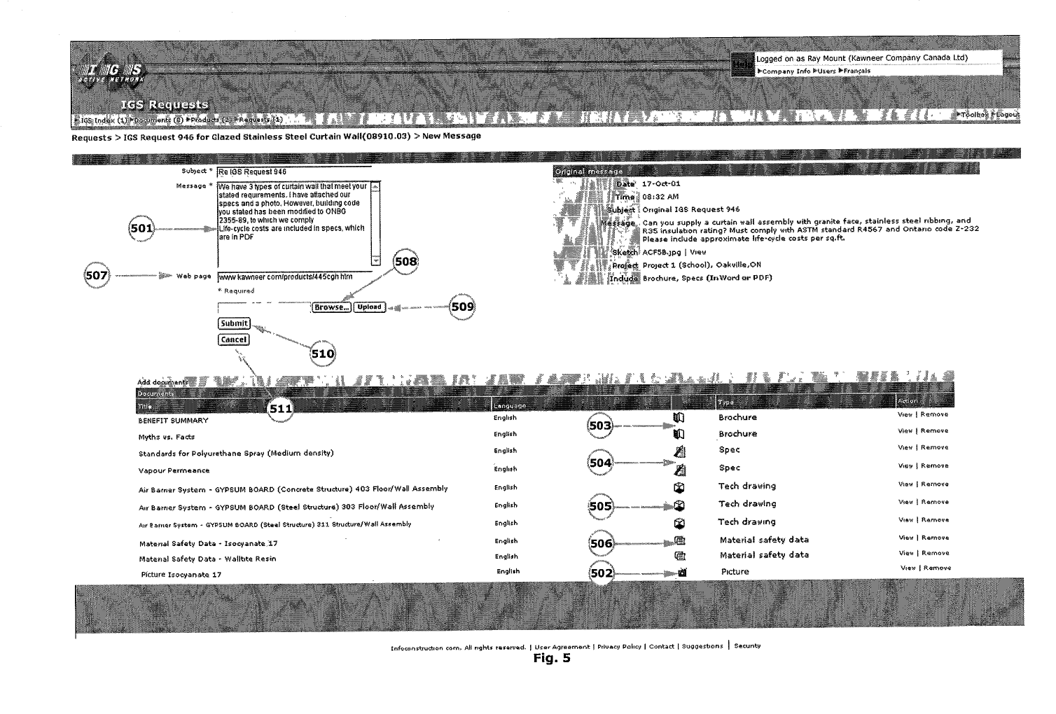

If the supplier responds affirmatively by clicking button 405, a response dialog box opens such as that shown in FIG. 5. The response dialog box allows the supplier to enter a text response to the building firm in text box 501. The supplier may preferably provide additional information such as a photograph 502, brochure 503, product specification 504, CAD file 505, MSDSs 506, or a link to the supplier's web site 507. The supplier clicks on the “browse” button 508 to access a dialog box that prompts the supplier to search for files on his computer. When the supplier has located the files containing the additional information, the supplier clicks an “upload” button 509, which then uploads the files to a virtual library 107 from which the building firm can download the files containing the additional information. By clicking the “submit” button 510, the supplier sends the text information to the building firm, for example, by e-mail, FTP, HTTP, or instant messaging. Alternatively, in the preferred embodiment, by clicking the “submit” button 510, the supplier sends the text information to the service, which then updates the building firm's archive, indicating the identities of the suppliers who responded, listing their messages, and indicating the presence on the service's virtual library of additional information that was uploaded by the suppliers. If the supplier wishes to cancel his response, he can do so by clicking on the “cancel” button 511.

In one embodiment of the invention, confirmed suppliers send text responses to requests for information and upload product information to a service computer. The service computer then provides notice to the building firm by e-mail, instant messaging, or by updating the building firm's archive. In the preferred embodiment, the service computer provides notice to the building firm of confirmed suppliers' responses to the building firm's request for information by updating the building firm's archive. The building firm may browse through its archive using a standard internet browser.

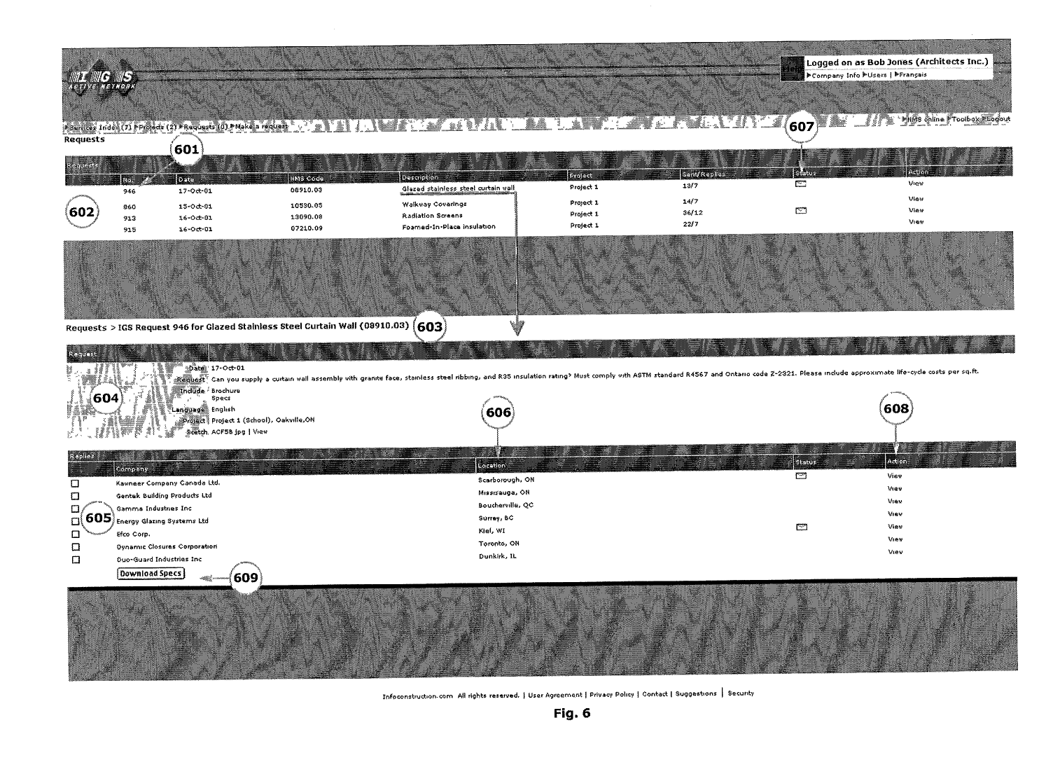

An example of how an internet browser may be used to browse through a building firm's archive is shown in FIG. 6. A list of the building firm's requests for information 602 provides details of the requests including the date the request was made, the CSI number corresponding to the product that the building firm obtained by searching or browsing through the supplier database, a brief textual description of the product, the number of suppliers to which requests for information were sent, the number of suppliers that replied to the requests for information, and the status of the request. The status indicator 607 informs the building firm when a new or updated response to the firm's request for information has been added to the firm's archive. The building firm may select a particular request 601 in order to browse through the responses to the selected request 601. The text field 603 specifies details about the selected request 601, and the text field 604 reproduces the text that the firm provided with its original request for information. A list of suppliers 605 who responded to the selected request 601 provides details about the suppliers and their responses, such as the location of the supplier 606, and whether the supplier has uploaded any additional information files 608. To review a response from any particular supplier, the building firm selects that supplier from the list 605. The building firm may download any additional information that the suppliers have uploaded by clicking the “Download Specs” button 609

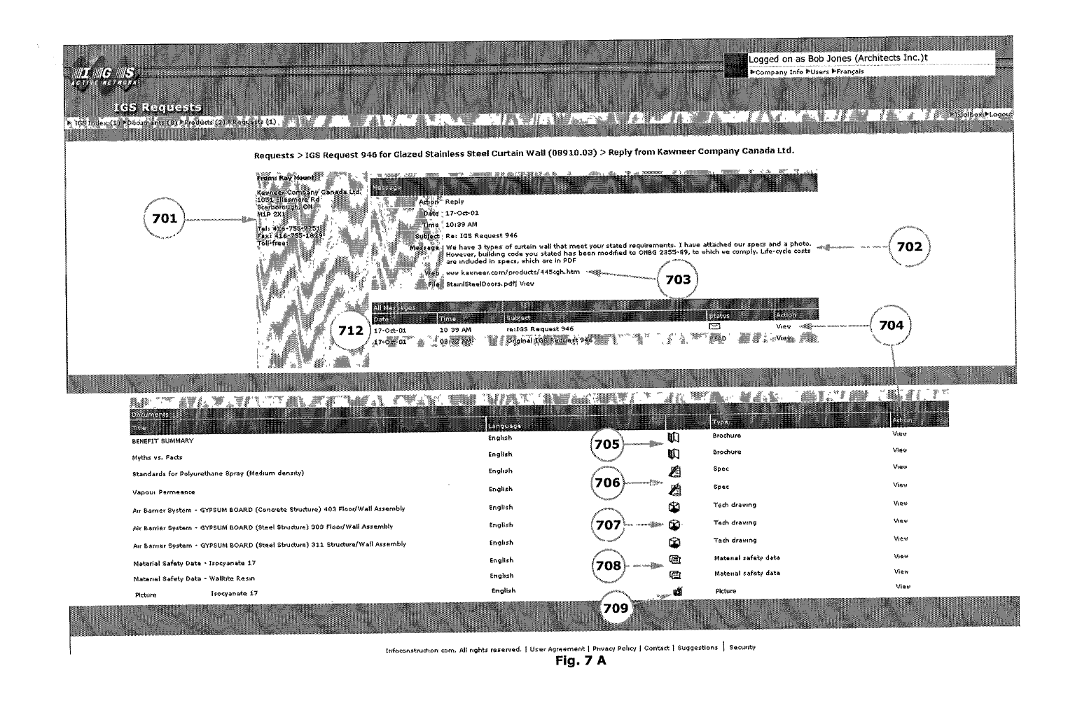

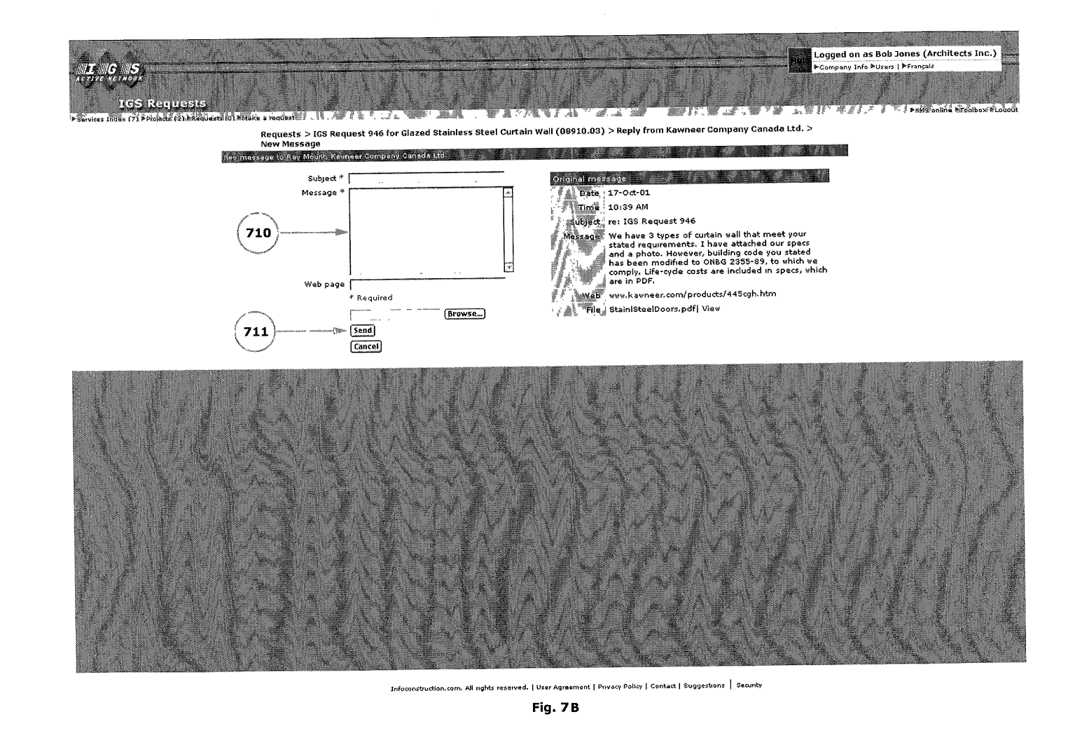

In one embodiment, such a selection results in the creation of a dialog box such as that depicted in FIG. 7A. The selected supplier is identified and its contact information is provided in text field 701. A record of all text correspondence between the building firm and the selected supplier is provided in text box 702, which allows the building firm to review any textual responses by the selected supplier to the firm's request for information. If the selected supplier maintains a web page, the URL for that web page is preferably provided in text field 703. Any additional information that the selected supplier has uploaded to the service computer may be indicated by icons 709 (photograph of the product), 705 (product brochures), 706 (product specifications), 707 (technical drawings), and 708 (MSDSs). A check over any of the icons 705-709 indicates that the selected supplier has uploaded the specified file. The building firm can download the files that the selected supplier has uploaded by clicking on the corresponding view button 704. The building firm can direct further inquiries to a specific supplier concerning the product by entering text in dialog box 710 from a request screen as depicted in FIG. 7B. Once the building firm has entered any further inquiries in dialog box 710, it clicks the “send” button 711 to send the inquiry, for example, by e-mail or instant messaging, to the selected supplier. This further inquiry is then added to the record of text correspondence 702, as is any response to the further inquiry provided by the selected supplier. A List of the inquiries sent by the firm and replies received from the supplier and the dates the inquiries were sent and the replies received is provided in text field 712. An additional feature of the system is that once a request has been submitted, the system can instantly forward the building firm a list of telephone contacts for companies that have been identified as being capable of meeting the specific requirements.

As previously described, the building firm may download any additional information that the suppliers have uploaded by clicking the “Download Specs” button 609. The icons correspond to links to the files that the suppliers have uploaded. However, it is not uncommon for suppliers to change or discontinue providing a product. When a supplier changes a product, they usually update the product specification, CAD file, brochure, or material safety data sheets (MSDS) featuring that product. Furthermore, a change in a product often results in a change in the appearance of that product. Therefore, the system of the invention allows the supplier who changes a product to upload new product specifications, CAD files, brochures, photographs, or MSDSs that overwrite the old files corresponding to the previous version of that product. Building firms are notified of such changes in their archives by the status indicator 607, which informs the firms that new information concerning that product is available. Thus the building firm can maintain an archive of up-to-date product information, even long after the firm's initial request for information, without having to contact each of the suppliers individually for updated information about their products.

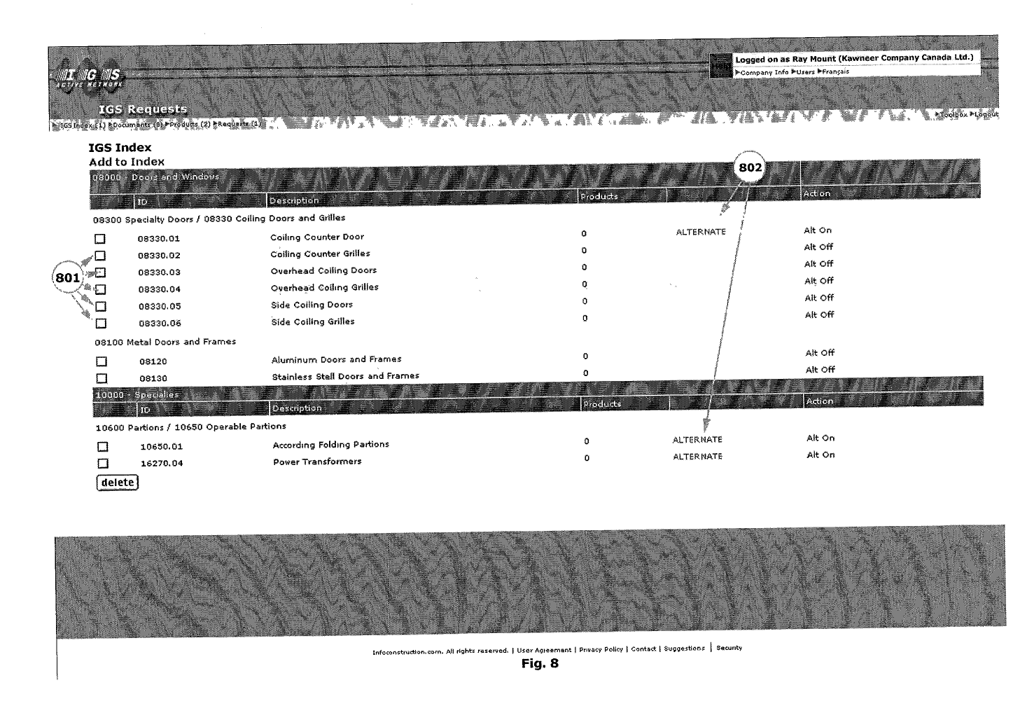

In a preferred embodiment, the supplier may modify his indexed product line tied to the IGS index as shown in FIG. 8, to add, remove, or update any product specifications, CAD files, brochures, photographs, or MSDSs. Products supplied by the supplier firm or products to which the supplier firm has alternatives 802 to any product they do not supply but might be requested are listed by IGS index number. This embodiment enables supplier firms to promote their products as alternatives to any product being sought by a building firm, but which the supplier firm does not produce. Thus, supplier firms may gain access to business that they would not otherwise have if they do not supply the particular product sought. Furthermore, building firms seeking particular products might benefit from the suggestions to use alternative products by being presented with otherwise unconsidered options for solving the building problem at hand. This embodiment allows a supplier to provide a response to a request from a building firm seeking a particular product, even if that supplier does not supply the particular product. If the supplier does supply the particular product, however, in addition to information about the particular product sought, he may also specify any alternative products that might be suitable for the requesting firm's needs.

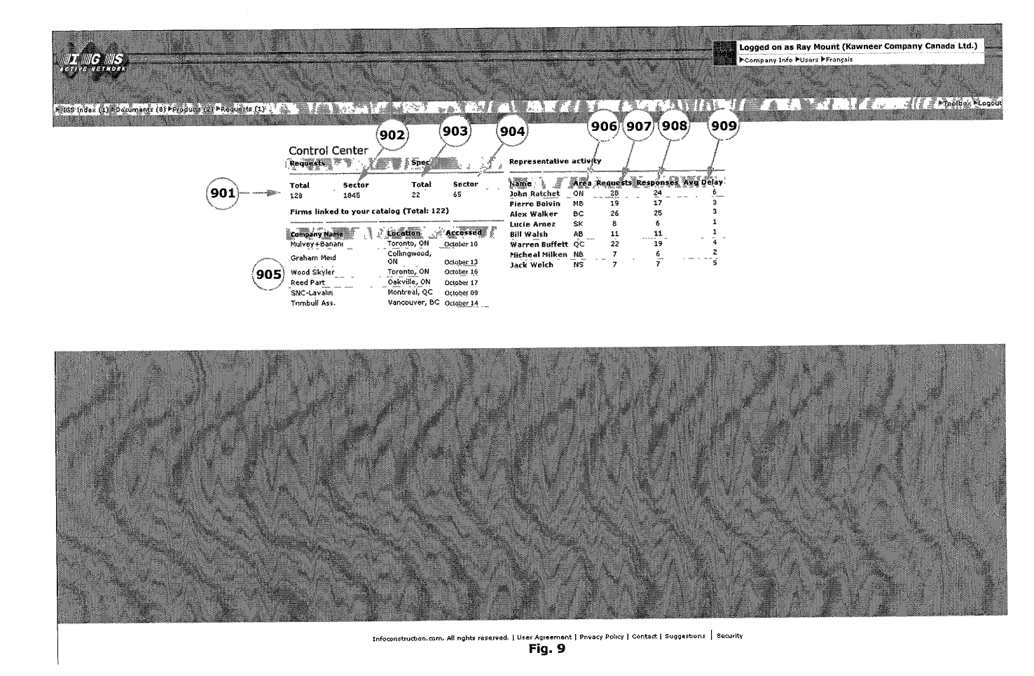

In a preferred embodiment, the supplier may access a control center such as that depicted in FIG. 9, from which he has the ability to track all activities related to his participation in the system and that would allow him to monitor all of his activities through the system as well as the performance of his sales force. The control center can be accessed by the supplier upon logging in to the system. It may list the total number of requests 901 set to him by building firms, as well as the total number of requests received by all suppliers in his sector 902. The control center thus provides suppliers with information about how often he receives requests relative to his competitors. The control center may also report the total number of times that various building firms have downloaded the specifications of his products 903, and how many times they have downloaded the specifications from all suppliers in his sector 904. The control center thus provides useful information to a supplier about the visibility of his business to his customers. The control center also provides information to a supplier as to which building firms have accessed the supplier's system-maintained catalog 905. The control center aspect of the invention thus represents an improvement over other forms of internet advertising, such as banner ads, because it provides the advertiser (in this case, the supplier) information as to the identity of the potential customers (in this case, the building firms), who have expressed an interest in the advertiser's products.

The control center allows the sales manager of a supplier to monitor the performance of his sales force by displaying summaries of each sales representative's activities. Each sales representative can be designated by the area he is assigned to sell in 906. The control center provides such information as how many requests each sales representative has received 907 and how many requests he has responded to 908, as well as the average time it took him to respond to the requests he received 909. Finally, the control center would allow a sales manager to monitor the communications between his sales force and the building firms requesting information.

It will be obvious from the foregoing specification that the invention may be varied in many ways without departing from the spirit and scope thereof. All such modifications are intended to be included within the scope of the invention which is defined by the following claims.

What is claimed is:

1. A method for identifying suppliers of a product comprising the steps of:
(a) providing a first electronic form, wherein said first electronic form allows a buyer to specify information about a product that said buyer wants to purchase;
(b) selecting one or more potential suppliers of said product by searching a database of suppliers for those that supply said product;
(c) sending a first electronic notification to said one or more potential suppliers of said product with the information about said product specified by the buyer, wherein said electronic notification allows said one or more potential suppliers of said product to confirm or deny that they can supply said product;
(d) selecting one or more potential suppliers of said product who confirmed that they can supply said product, thereby selecting one or more confirmed suppliers; and
(e) providing a second electronic notification to said buyer from said one or more confirmed suppliers, wherein said second electronic notification identifies said one or more confirmed suppliers.

2. The method of claim 1, wherein the buyer specifies a geographical location, and wherein said step of selecting one or more potential suppliers of said product is determined by said geographical location.

3. The method of claim 1, further comprising the steps of:
(f) providing a second electronic form into which the buyer enters the buyer's contact information; and
(g) electronically storing the buyer's contact information.

4. The method of claim 1, further comprising the steps of:
(f) selecting one or more potential suppliers of said product who denied that they can supply said product, thereby selecting one or more denied suppliers; and
(g) updating said database of suppliers to reflect that said one or more denied suppliers do not supply said product.

5. The method of claim 4, wherein said one or more confirmed suppliers upload a specification for said product.

6. The method of claim 5, wherein said buyer downloads said specification of said product.

7. The method of claim 6, wherein said buyer builds a library of specifications of products.

8. The method of claim 6, wherein said buyer is selected from the group consisting of: an architect, an architectural firm, a builder, a construction firm, a carpenter, a carpentry firm, an interior designer, an interior design firm, a landscaper, a landscaping firm, an electrician, an electrical firm, a plumber, and a plumbing firm.

9. The method of claim 6, wherein said one or more potential suppliers supply building supplies, electrical supplies, plumbing supplies, or interior decorating supplies.

10. A method for identifying suppliers of a product and providing a specification for the product, comprising the steps of:
(a) providing a first electronic form, wherein said first electronic form allows a buyer to specify information about a product that said buyer wants to purchase;
(b) providing a second electronic form, wherein said second electronic form allows said buyer to list buyer's contact information;
(c) electronically storing said buyer's contact information.
(d) selecting two or more potential suppliers of said product by searching a database of suppliers for those that supply said product;
(e) sending a first electronic notification to said two or more potential suppliers of said product with the information about said product specified by the buyer, wherein said electronic notification allows said two or more potential suppliers of said product to confirm or deny that they can supply said product;
(f) selecting one or more potential suppliers of said product who confirmed that they can supply said product, thereby selecting one or more confirmed suppliers, wherein said one or more confirmed suppliers uploads a specification for said product;
(g) providing a second electronic notification to said buyer from said one or more confirmed suppliers, wherein said second electronic notification identifies said one or more confirmed suppliers, and wherein said buyer downloads said specification of said product;
(h) selecting one or more potential suppliers of said product who denied that they can supply said product, thereby selecting one or more denied suppliers; and
(i) updating said database of suppliers to reflect that said one or more denied suppliers do not supply said product.

11. A method for updating a database of suppliers comprising the steps of:
(a) providing an electronic form to one or more suppliers requesting said one or more suppliers respond to a query as to whether or not said one or more suppliers supply a product;
(b) identifying suppliers who respond to said query in the negative, thereby selecting one or more denied suppliers; and
(c) updating said database of suppliers to reflect that said one or more denied suppliers do not supply said product.

12. A system for identifying suppliers of a product and providing a specification for the product, comprising:
(a) a means for providing a first electronic form, wherein said first electronic form allows a buyer to specify information about a product that said buyer wants to purchase;
(b) a means for selecting two or more potential suppliers of said product by searching a database of suppliers for those that supply said product;
(c) a means for sending a first electronic notification to said two or more potential suppliers of said product with the information about said product specified by the buyer, wherein said electronic notification allows said two or more potential suppliers of said product to confirm or deny that they can supply said product;
(d) a means for selecting one or more potential suppliers of said product who confirmed that they can supply said product, thereby selecting one or more confirmed suppliers;
(e) a means for uploading a specification for said product;
(f) a means for providing a second electronic notification to said buyer from said one or more confirmed suppliers, wherein said second electronic notification identifies said one or more confirmed suppliers;
(g) a means for downloading said specification of said product;
(h) a means for selecting one or more potential suppliers of said product who denied that they can supply said product, thereby selecting one or more denied suppliers; and
(i) a means for updating said database of suppliers to reflect that said one or more denied suppliers do not supply said product.

13. The system of claim 12, further comprising:
(j) a means for providing a second electronic form, wherein said second electronic form allows said buyer to list buyer's contact information;
(k) a means for electronically storing said buyer's contact information.

14. The system of claim 13, further comprising a means for building a library of specifications.

15. The system of claim 13, wherein said buyer is selected from the group consisting of: an architect, an architectural firm, a builder, a construction firm, a carpenter, a carpentry firm, an interior designer, an interior design firm, a landscaper, a landscaping firm, an electrician, an electrical firm, a plumber, and a plumbing firm.

16. The system of claim 14, wherein said one or more potential suppliers supply building supplies, electrical supplies, plumbing supplies, or interior decorating supplies.

17. The system of claim 12, further comprising a means for specifying a geographical location, wherein said first electronic notification is sent to said two or more potential suppliers within said geographical region.

18. A method of finding a product within an electronic database comprising a group of construction-related products, wherein each member of said group of construction-related products is associated with a list of suppliers of each member of said group of construction-related products, and wherein said each member is a subcategory of the most specific category of the Construction Specification Institute MasterFormat Index™.

19. A method for identifying suppliers of a product by a buyer comprising the steps of:
(a) specifying information about a product that said buyer wants to purchase, wherein said information allows the selection of one or more potential suppliers of said product by searching a database of suppliers for those that supply said product, wherein a first electronic notification is sent to said one or more potential suppliers of said product with the information about said product specified by the buyer, wherein said electronic notification allows said one or more potential suppliers of said product to confirm or deny that they can supply said product, and wherein one or more potential suppliers of said product who confirmed that they can supply said product is selected; and
(b) contacting one or more confirmed suppliers in provided in a second electronic notification to said buyer, wherein said second electronic notification identifies said one or more confirmed suppliers.

20. The method of claim 19, further comprising specifying a geographical location, wherein said one or more confirmed suppliers of are selected on the basis of proximity to that geographical location.
